(19) United States
(12) Patent Application Publication
(10) Pub. No.: US 2020/0353568 A1
(43) Pub. Date: Nov. 12, 2020

(54) DISPLAY PANEL CUTTING APPARATUS AND CUTTING METHOD USING THE SAME

(71) Applicant: SAMSUNG DISPLAY CO., LTD., YONGIN-SI (KR)

(72) Inventors: Jeong Hoo LEE, Cheonan-si (KR); Yong Woon BYUN, Asan-si (KR); Ji Seop SHIN, Cheonan-si (KR); Seong Min HONG, Daejeon (KR)

(21) Appl. No.: 16/705,494

(22) Filed: Dec. 6, 2019

(30) Foreign Application Priority Data
May 8, 2019 (KR) 10-2019-0053614

(51) Int. Cl. B23K 26/38; B23K 26/142

(52) U.S. Cl. CPC B23K 26/38; B23K 26/142

(57) ABSTRACT

A display panel cutting apparatus including: a stage, wherein a display panel is disposed on the stage, and the display panel includes a display area, a non-display area, and a test pad portion; an air knife disposed on the stage; an upper supporting member overlapping the test pad portion; and a laser that cuts the test pad portion from the display panel, wherein the upper supporting member is separated from an upper surface of the test pad portion.

### CROSS-REFERENCE TO RELATED APPLICATION

This application claims priority under 35 U.S.C. § 119 to Korean Patent Application No. 10-2019-0053614 filed in the Korean Intellectual Property Office on May 8, 2019, the disclosure of which is incorporated by reference herein in its entirety.

### TECHNICAL FIELD

The present invention relates to a display panel cutting apparatus and a cutting method using the same.

### DISCUSSION OF THE RELATED ART

Types of display panels include, for example, liquid crystal displays (LCDs) and organic light emitting diode (OLED) displays.

Conventionally, a rigid substrate made of a material such as glass may be used as a substrate of a display panel, but recently, a flexible substrate made of a material such as plastic has been used in many display panels.

For example, an organic light emitting diode display using the flexible substrate may include a display unit including an organic light emitting diode, a driving circuit unit, and a non-display unit including a test pad unit, and a panel inspection process is performed to determine whether there is a short or a disconnection in wiring formed in the display area.

In addition, after the panel inspection process is finished, a cutting process is typically performed to cut the test pad portion of the non-display area to reduce the size of the non-display area of the display device.

### SUMMARY

According to an exemplary embodiment of the present invention, a display panel cutting apparatus including; a stage, wherein a display panel is disposed on the stage, and the display panel includes a display area, a non-display area, and a test pad portion; an air knife disposed on the stage; an upper supporting member overlapping the test pad portion; and a laser that cuts the test pad portion from the display panel, wherein the upper supporting member is separated from an upper surface of the test pad portion.

In an exemplary embodiment of the present invention, the upper supporting member includes: a first portion facing the upper surface of the test pad portion; a second portion connected to the first portion and fixing the first portion; and a third portion connected to the second portion and substantially perpendicular to the second portion.

In an exemplary embodiment of the present invention, one section of the first portion extends parallel to a cutting line formed between the non-display area and the test pad portion on the display panel.

In an exemplary embodiment of the present invention, the first portion of the upper supporting member includes acryl.

In an exemplary embodiment of the present invention, a distance between a lower surface of the first portion of the upper supporting member and the upper surface of the test pad portion is about 2 mm.

In an exemplary embodiment of the present invention, a width of the first portion of the upper supporting member is about 10 mm.

In an exemplary embodiment of the present invention, the third portion of the upper supporting member includes a shaft, and

the shaft adjusts a height of the upper supporting member.

In an exemplary embodiment of the present invention, the display panel cutting apparatus further includes an inclination supporting member disposed at an incline with respect to the upper supporting member.

In an exemplary embodiment of the present invention, the laser generates green light having a wavelength of about 500 nm to about 550 nm.

In an exemplary embodiment of the present invention; the display panel cutting apparatus further includes a work table disposed under the stage and the upper supporting member, wherein the work table includes a position adjustment unit that adjusts a position of the stage and the upper supporting member.

According to an exemplary embodiment of the present invention, a display panel cutting apparatus includes: a laser that cuts a test pad portion from the display panel, wherein the display panel includes a display area and a non-display area; an air knife that separates the cut test pad portion; an upper supporting member including a first portion, a second portion and a third portion, wherein the first portion faces an upper surface of the test pad portion, wherein the second portion is connected to the first portion, and wherein the third portion is connected to the second portion; and an inclination supporting member disposed at an incline with respect to the upper supporting member, wherein the first portion of the upper supporting member is separated from an upper surface of the test pad portion.

In an exemplary embodiment of the present invention, one section of the first portion extends parallel to a cutting line formed between the non-display area and the test pad portion on the display panel.

In an exemplary embodiment of the present invention, the first portion of the upper supporting member includes acryl.

In an exemplary embodiment of the present invention, a distance between a lower surface of the first portion of the upper supporting member and the upper surface of the test pad portion is about 2 mm.

According to an exemplary embodiment of the present invention, a display panel cutting method includes: disposing a display panel on an upper surface of a stage of a display panel cutting apparatus, wherein the display panel includes a display area, a non-display area, and a test pad portion; disposing an upper supporting member on the display panel cutting apparatus such that it is separated from an upper surface of the test pad portion of the display panel; and cutting the test pad portion from the display panel by using a laser.

In an exemplary embodiment of the present invention, the display panel cutting method further includes separating the test pad portion from the display panel by using an air knife, wherein the test pad portion is moved in a direction under the display panel by using the upper supporting member.

In an exemplary embodiment of the present invention, the upper supporting member includes: a first portion facing the upper surface of the test pad portion; a second portion connected to the first portion to fix the first portion; and a third portion connected to the second portion and substantially perpendicular to the second portion.

In an exemplary embodiment of the present invention, the first portion of the upper supporting member includes acryl.

In an exemplary embodiment of the present invention, the upper supporting member is disposed on the display panel cutting apparatus such that a lower surface of the first portion is separated from the upper surface of the test pad portion by about 2 mm.

In an exemplary embodiment of the present invention, the laser generates green light having a wavelength of about 500 nm to about 550 nm.

### BRIEF DESCRIPTION OF THE DRAWINGS

FIG. 1 is a view schematically showing a display panel according to an exemplary embodiment of the present invention;

FIG. 2 is a schematic lateral view of a display panel cutting apparatus according to an exemplary embodiment of the present invention;

FIG. 3 is a perspective view of a display panel cutting apparatus according to an exemplary embodiment of the present invention;

FIG. 4 is a plan view of a display panel cutting apparatus according to an exemplary embodiment of the present invention;

FIG. 5 is a flowchart of a display panel cuffing method using a display panel cutting apparatus according to an exemplary embodiment of the present invention;

FIG. 6 is a view showing an upper supporting member of a display panel cutting apparatus according to an exemplary embodiment of the present invention;

FIG. 7 is a view showing an upper supporting member of a display panel cutting apparatus according to an exemplary embodiment of the present invention; and

FIG. 8, FIG. 9, and FIG. 10 show failures generated in separated display panels after cutting a test pad portion according to a comparative example.

### DETAILED DESCRIPTION OF THE EMBODIMENTS

The present invention will be described more fully hereinafter with reference to the accompanying drawings. It is to be understood that the described exemplary embodiments of the present invention may be modified in various different ways without departing from the spirit or scope of the present invention.

It is to be understood that like reference numerals may denote like elements throughout the specification, and thus, repetitive descriptions may be omitted.

In addition, the size and thickness of each configuration shown in the drawings may be exaggerated for clarity, but the present invention is not limited thereto.

It will be understood that when an element such as a layer, film, region, or substrate is referred to as being “on” another element, it can be directly on the other element or intervening elements may also be present. In addition, when an element is referred to as being “directly on” another element, there are no intervening elements present.

Further, throughout this specification, the phrase “on a plane” may mean a target part is viewed from the top, and the phrase “on a cross-section” may mean when a cross-section of the target part vertically taken is viewed from the side.

First, a display panel provided to a display panel cutting apparatus according to an exemplary embodiment is described with reference to FIG. it. Here, as an example, the display panel may be a panel for an organic light emitting diode display.

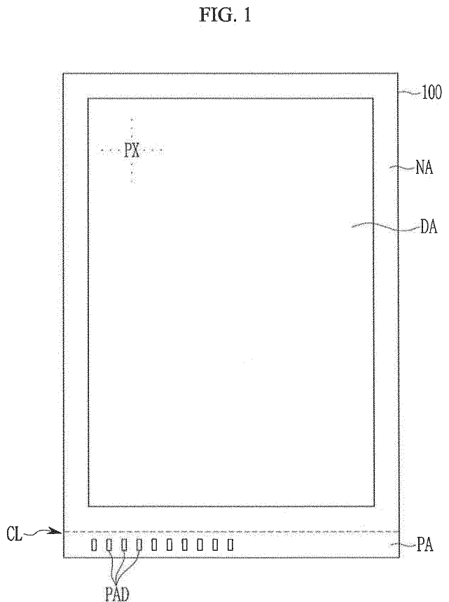

FIG. 1 is a view schematically showing a display panel according to an exemplary embodiment of the present invention.

Referring to FIG. 1, a substrate of a display panel 100 includes a display area DA and a non-display area NA. The display area is a region where an image is displayed, and the non-display area NA is a region where the image is not displayed. For example, the substrate of the display panel 100 may be made of a flexible material such as polyimide (PI), polycarbonate (PC), or the like.

The display area includes a plurality of pixels PX, and one pixel PX includes a pixel circuit and an organic light emitting element (OLED) that receives a current therefrom to emit light.

The non-display area NA is a region at least partially surrounding the display area DA in which a plurality of wires, a gate driver, a data driver, and a test pad portion PA are disposed to apply a signal to the pixel PX of the display area DA.

The test pad portion PA is disposed adjacent to a side of the display panel 100. For example, the test pad portion PA may be disposed at the bottom of the display panel 100. In addition, the test pad portion PA may be distinguished from the non-display area NA disposed at the top, bottom, and sides of the display panel 100 by the cutting line CL. The test pad portion PA is a portion that is cut away from the display panel 100, and is a portion that should be removed to apply a signal to the display area DA and to display an image. The test pad portion PA may be cut by the panel cutting apparatus after a panel inspection process is performed to check a driving state and to determine whether the wiring formed in the display area DA has no problems such as a short or disconnection.

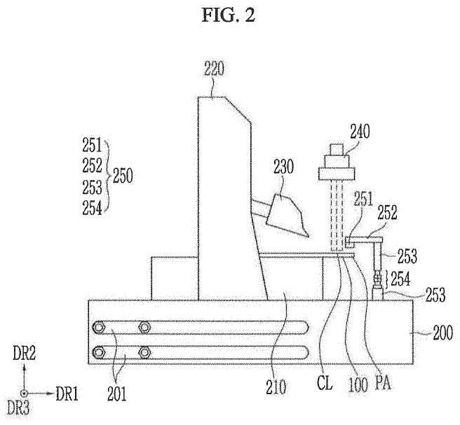

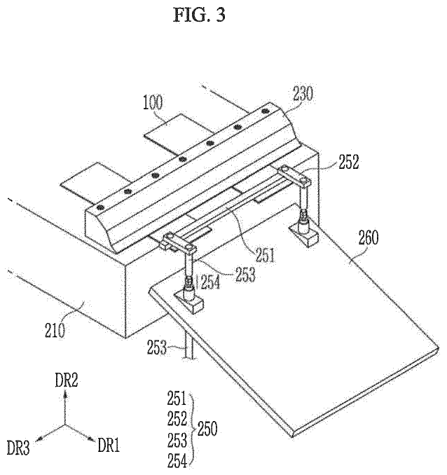

Hereinafter, a display panel cutting apparatus according to an exemplary embodiment of the present invention to cut the test pad portion is described with reference to FIG. 2 to FIG. 4.

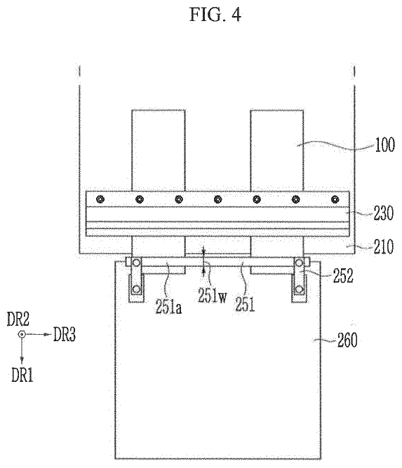

FIG. 2 is a schematic lateral view of a display panel cutting apparatus according to an exemplary embodiment of the present invention, FIG. 3 is a perspective view of a display panel cutting apparatus according to an exemplary embodiment of the present invention, and FIG. 4 is a plan view of a display panel cutting apparatus according to an exemplary embodiment of the present invention.

According to an exemplary embodiment of the present invention, with reference to FIG. 2 to FIG. 4, a display panel cutting apparatus includes a stage 210 disposed on a work table 200, an upper bracket 220, an air knife 230, a laser 240, an upper supporting member 250, and an inclination supporting member 260.

The stage 210, the upper bracket 220, the air knife 230, the laser 240, the upper supporting member 250, and the inclination supporting member 260 are disposed on the work table 200, and the stage 210, the upper bracket 220, the upper supporting member 250, and the inclination supporting member 260 are fixed by the work table 200. The work table 200 further includes a position adjustment unit 201 to adjust the upper supporting member 250, such that the upper supporting member 250 can be moved in the first direction DR1. In addition, the stage 210 may be moved in the first direction DR1 by the position adjustment unit 201. However, the present invention is not limited thereto. For example, in an exemplary embodiment of the present invention, the stage 210 may be moved in the first direction DR1 and the upper supporting member 250 may be stationary. In addition, the position adjustment unit 201, for example, may be an actuator and may include a micromotor.

The stage 210 includes an upper surface on a horizontal plane to support the display panel 100. The display area DA and the non-display area NA of the display panel 100 are disposed on the upper surface of the stage 210, and the test pad portion. PA is disposed outside of the upper surface of the stage 210. For example, the test pad portion PA does not overlap the upper surface of the stage 210 and extends beyond the upper surface of the stage 210. Two display panels 100 may be disposed on one stage 210, and the number of display panels 100 disposed on the stage 210 may be varied depending on the size of the display panel 100. In addition, the stage 210 may be adjusted so that its position on the work table 200 may move in the first direction DR1 by the position adjustment unit 201 of the work table 200 depending on the size and number of display panels 100.

The upper bracket 220 is connected to the stage 210 and extends in a second direction DR2 perpendicular to the upper surface of the stage 210.

The air knife 230 is connected to the upper bracket 220, and the air knife 230 is disposed toward the periphery of the cutting line CL between the non-display area NA and the test pad portion PA. The air knife 230 supplies air in a cutting process of the test pad portion PA so that the cut test pad portion. PA may be separated from the display panel 100. The air from the air knife 230 may push the cut test pad portion PA away from the display panel 100 in any direction.

The laser 240 is disposed above the cutting line CL of the display panel 100 to emit light so that the test pad portion PA is separated from the display panel 100. The laser 240 may be disposed in the non-display area NA adjacent to the cutting line CL and part of the test pad portion PA to irradiate along the cutting line CL. In addition, the laser 240 may be disposed above the stage 210 and may emit light so that the test pad portion PA is separated from the display panel 100. For example, the laser 240 may be implemented as a green laser that emits green light having a wavelength of about 500 nm to about 550 nm.

The upper supporting member 250 according to an exemplary embodiment of the present invention includes a first portion 251, a second portion 252, and a third portion 253.

The first portion 251 is a horizontal portion facing the upper surface of the display panel 100 and is disposed to face the test pad portion PA among the display panel 100. The first portion 251 overlaps an upper region of the test pad portion PA and is elongated in the third direction DR3 along the cutting line CL of the display panel 100. Thus, one end. (e.g., section) 251a of the first portion 251 may be disposed to coincide with the cutting line CL of the display panel 100. The lower surface of the first portion 251 is spaced apart from the upper surface of the test pad portion PA. For example, the lower surface of the first portion 251 may be spaced apart from the upper surface of the test pad portion PA by about 2 mm. A width 251w of the first portion 251 may be formed with the same width as the width of the test pad portion PA, which may be about 10 mm. For example, the first portion 251 may be made of a transparent acryl or the like.

The second portion 252 is a portion that is in contact with the upper surface of the first portion 251 to support a portion of the first portion 251 so that the first portion 251 may be fixed. One first portion 251 is connected to two second portions 252. The two second portions 252 are disposed on respective sides of the first portion 251, and are spaced apart by the distance equal to about the width of the display panel 100. According to an exemplary embodiment of the present invention, the position and number of the second portions 252 for supporting the first portion 251 may be variously implemented.

The third portion 253 is a portion that is connected to the second portion 252 and the work table 200, and is disposed to be extended in the second direction DR2. The third portion 253 is a portion of the upper supporting member 250 that supports the upper supporting member 250 to be supported in the vertical direction, i.e., in the second direction DR2.

A shaft 254 is a portion of the third portion 253, and the shaft 254 is a portion that adjusts the height of the upper supporting member 250. The shaft 254 allows the upper supporting member 250 to move in the second direction DR2. For example, the shaft 254 may have sections that slide in and out of each other and may include an actuator and/or a micromotor to adjust the height of the upper supporting member 250. According to an exemplary embodiment of the present invention, the third portion 253 does not include the shaft 254, but may be formed continuously to connect the second portion 252 and the work table 200 to each other.

In addition, one end of the third portion 253 is connected to the position adjustment unit 201 of the work table 200 so that the upper supporting member 250 may be adjusted to move freely in the first direction DR1. In an exemplary embodiment of the present invention, the stage 210 may be connected to the position adjustment unit 201 so that the stage 210 may be adjusted to move along the first direction DR1.

The inclination supporting member 260 is connected to the third portion 253 of the upper supporting member 250, and the inclination supporting member 260 is positioned to be inclined at an angle with respect to a side surface of the work table 200 so that the cut test pad portion PA may drop in the direction under the display panel 100. For example, the cut test pad portion PA may slide down the inclination supporting member 260.

In the display panel cutting apparatus according to an exemplary embodiment of the present invention, because the separated test pad portion PA fails in the lower direction of the display panel 100 by the upper supporting member 250 and the inclination supporting member 260, the present invention can prevent the generation of laser-based scratch diffused reflection failures in the display panel as the cut test pad portion PA is scattered in the upper direction of the display panel.

In addition, during the cutting process of the display panel, in a comparative example that includes a lower supporting member instead of the upper supporting member, carbonization failure occurs on the cut cross-section of the display panel due to the contact portion of the lower supporting member and the display panel. However, in the display panel cutting apparatus according to an exemplary embodiment of the present invention, since the first portion 251 of the upper supporting member 250 is not in contact with the display panel 100, it is possible to prevent the carbonization failure from occurring on the cut cross-section of the display panel 100.

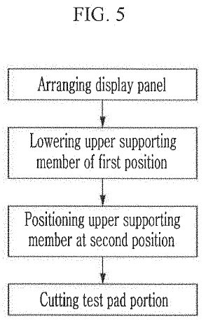

Next, a cutting method using the display panel cutting apparatus according to an exemplary embodiment of the present invention is described with reference to FIG. 5 to FIG. 7.

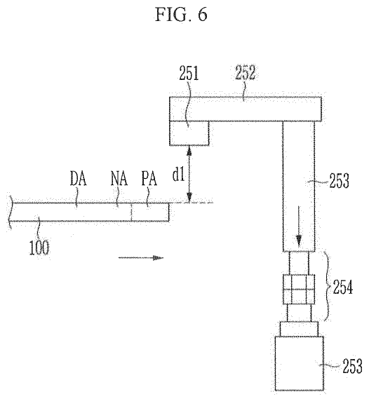

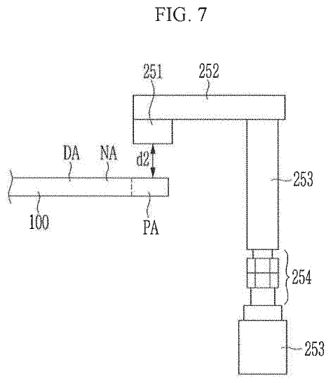

FIG. 5 is a flowchart of a display panel cutting method using a display panel cutting apparatus according to an exemplary embodiment of the present invention, and FIG. 6 and FIG. 7 are views showing an adjusted upper supporting member of a display panel cutting apparatus according to an exemplary embodiment of the present invention,

FIG. 5 to FIG. 7 are described with reference to FIG. 2 to FIG. 4 since the display panel cutting apparatus according to an exemplary embodiment of the present invention is used.

The display panel 100, after an inspection process has finished, is disposed on the upper surface of the stage 210. The display panel 100 is disposed so that the display area DA and the non-display area NA of the display panel 100 are placed on the upper surface of the stage 210 and the test pad portion PA of the display panel 100 extends beyond the upper surface of the stage 210.

The upper supporting member 250 moves between a first position and a second position. For example, the upper supporting member 250 is at the first position and then descends to the second position. The first position is a position where the upper supporting member 250 is disposed before the display panel 100 such that the upper supporting member 250 does not overlap the display panel 100. For example, the upper supporting member 250 may be disposed adjacent to the display panel 100. The second position is a position where the upper supporting member 250 is disposed before the display panel cutting process is performed. For example, die second position may be a position where the upper supporting member 250 overlaps the test pad portion PA.

The upper supporting member 250 disposed at the first position and the second position is described with reference to FIG. 6 and FIG. 7.

FIG. 6 shows the upper supporting member 250 before the display panel cutting process is performed, and the upper supporting member 250 is disposed at the first position. When the upper supporting member 250 is disposed at the first position, a distance d1 (e.g., a first distance) between the lower surface of the first portion 251 of the upper supporting member 250 and the upper surface of the test pad portion PA of the display panel 100 is about 2 mm or more. Here, the first portion 251 may vary in height within the range of motion of the shaft 254.

FIG. 7 shows when the upper supporting member 250 is disposed to overlap the display panel 100 during the cutting process of the display panel 100, and the upper supporting member 250 is disposed at the second position. When the upper supporting member 250 is disposed at the second position, the distance d2 (e.g., a second distance) between the lower surface of the first portion 251 of the upper supporting member 250 and the upper surface of the test pad portion PA of the display panel 100 is about 2 mm. For example, the second distance d2 may be less than the first distance d1.

If the upper supporting member 250 is disposed at the second position, the laser 240 irradiates the cutting line CL of the display panel 100 to cut the test pad portion PA.

The cut test pad portion PA is separated from the display panel 100 by the air knife 230, and is pushed away from the display panel 100 by the air knife 230. At this time, the test pad portion PA does not move in an upward direction with respect to the display panel 100 due to the first portion. 251 of the upper supporting member 250, but the test pad portion PA falls downwardly. Therefore, since the cut test pad portion PA does not move in the upward direction, it is possible to prevent the laser-based scratch diffused reflection failure that may occur in the display panel 100 without affecting the separated display panel 100.

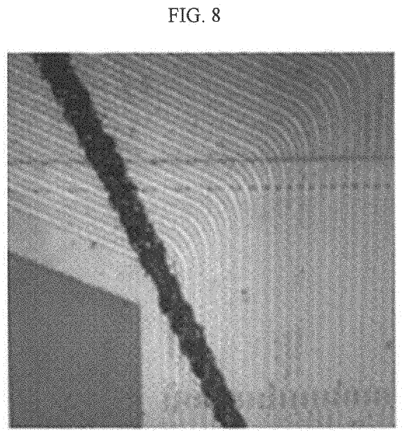

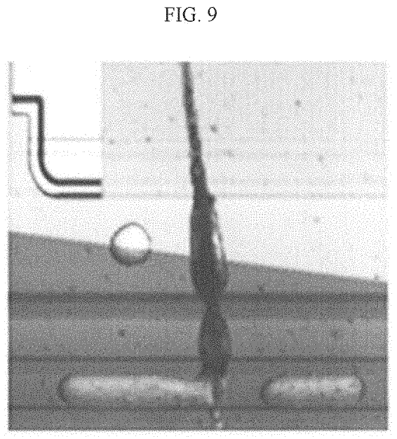

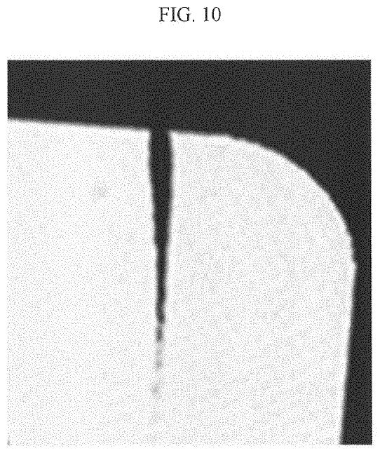

In addition, the display panel cutting apparatus according to a comparative example does not include the upper supporting member so that the cut test pad portion is moved in the upper direction. Next, the failure generated in the separated display panel after the cutting process according to the comparative example is described with reference to FIG. 8 to FIG. 10.

FIG. 8, FIG. 9, and FIG. 10 are pictures showing failures generated in separated display panels after cutting a test pad portion according to a comparative example.

Referring to FIG. 8, FIG. 9, and FIG. 10, a scratch is generated in the display panel. The black portion of the display panel is the laser-based scratch that occurs when the cut test pad portion is separated from display panel.

However, since the display panel cutting apparatus according to an exemplary embodiment of the present invention includes the upper supporting member and the cut test pad portion drops downward in the lower direction, the laser-based scratch failure due to the scattering of the cut test pad portion in the upper direction may be prevented.

Table 1 and Table 2 show the effect of the present invention in numerical terms. Table 1 shows an inferiority rate of the laser-based scratch generated in the display panel when using the display panel cutting apparatus according to a comparative example, and Table 2 shows the inferiority rate of the laser based scratch generated in the display panel when using the display panel cutting apparatus according to an exemplary embodiment of the present invention.

TABLE 1

| Model | | Scratch failure number | | | Laser-based |
|---|---|---|---|---|---|
| | Progress | Occurrence | Laser- | | failure rate |
| | number | number | based | Caustic | (PPM) |
| A | 97,785 | 1237 | 1070 | 167 | 10,942 |
| DELETED | | | | | |
| TEXTS | | | | | |
| B | 253,757 | 1126 | 260 | 866 | 1025 |
| DELETED | | | | | |
| TEXTS | | | | | |

TABLE 2

| Model | | Scratch failure number | | | Laser-based |
|---|---|---|---|---|---|
| | Progress | Occurrence | Laser- | | failure rate |
| | number | number | based | Caustic | (PPM) |
| A | 97,785 | 1237 | 0 | 167 | 0 |
| DELETED | | | | | |
| TEXTS | | | | | |
| B | 253,757 | 1126 | 0 | 866 | 0 |
| DELETED | | | | | |
| TEXTS | | | | | |

Compared with the laser-based scratch failure rates shown in Table 1 and Table 2, in the display panel according to an exemplary embodiment of the present invention, the laser-based scratch inferiority rate is generated as 0 as shown in Table 2.

While the present invention has been shown and described with reference to the exemplary embodiments thereof, it will be apparent to those of ordinary skill in the art that various changes in form and detail may be made thereto without departing from the spirit and scope of the present invention.

What is claimed:

1. A display panel cutting apparatus comprising:
a stage, wherein a display panel is disposed on the stage, and the display panel includes a display area, a non-display area, and a test pad portion;
an air knife disposed on the stage;
an upper supporting member overlapping the test pad portion; and
a laser that cuts the test pad portion from the display panel,
wherein the upper supporting member is separated from an upper surface of the test pad portion.

2. The display panel cutting apparatus of claim 1, wherein
the upper supporting member includes:
a first portion facing the upper surface of the test pad portion;
a second portion connected to the first portion and fixing the first portion; and
a third portion connected to the second portion and substantially perpendicular to the second portion.

3. The display panel cutting apparatus of claim 2, wherein
one section of the first portion extends parallel to a cutting line formed between the non-display area and the test pad portion on the display panel.

4. The display panel cutting apparatus of claim 2, wherein
the first portion of the upper supporting member includes acryl.

5. The display panel cutting apparatus of claim 2, wherein
a distance between a lower surface of the first portion of the upper supporting member and the upper surface of the test pad portion is 2 mm.

6. The display panel cutting apparatus of claim 2, wherein
a width of the first portion of the upper supporting member is 10 mm.

7. The display panel cutting apparatus of claim 2, wherein
the third portion of the upper supporting member includes a shaft, and
the shaft adjusts a height of the upper supporting member.

8. The display panel cutting apparatus of claim 1, further comprising:
an inclination supporting member disposed at an incline with respect to the upper supporting member.

9. The display panel cutting apparatus of claim 1, wherein
the laser generates green light having a wavelength of 500 nm to 550 nm.

10. The display panel cutting apparatus of claim 1, further comprising:
a work table disposed under the stage and the upper supporting member,
wherein the work table includes a position adjustment unit that adjusts a position of the stage and the upper supporting member.

11. A display panel cutting apparatus comprising:
a laser that cuts a test pad portion from the display panel, wherein the display panel includes a display area and a non-display area;
an air knife that separates the cut test pad portion;
an upper supporting member including a first portion, a second portion and a third portion, wherein the first portion faces an upper surface of the test pad portion, wherein the second portion is connected to the first portion, and wherein the third portion is connected to the second portion; and
an inclination supporting member disposed at an incline with respect to the upper supporting member,
wherein the first portion of the upper supporting member is separated from an upper surface of the test pad portion.

12. The display panel cutting apparatus of wherein
one section of the first portion extends parallel to a cutting line formed between the non-display area and the test pad portion on the display panel.

13. The display panel cutting apparatus of claim 11, wherein
the first portion of the upper supporting member includes acryl.

14. The display panel cutting apparatus of claim 11, wherein
a distance between a lower surface of the first portion of the upper supporting member and the upper surface of the test pad portion is 2 mm.

15. A display panel cutting method, the method comprising:
disposing a display, panel on an upper surface of a stage of a display panel cutting apparatus, wherein the display panel includes a display area, a non-display area, and a test pad portion;
disposing an upper supporting member on the display panel cutting apparatus such that it is separated from an upper surface of the test pad portion of the display panel; and
cutting the test pad portion from the display panel by using a laser.

16. The display panel cutting method of claim 15, further comprising
separating the test pad portion from the display panel by using an air knife,
wherein the test pad portion is moved in a direction under the display panel by using the upper supporting member.

17. The display panel cutting method of claim 15, wherein
the upper supporting member includes:
a first portion facing the upper surface of the test pad portion;
a second portion connected to the first portion to fix the first portion; and
a third portion connected to the second portion and substantially perpendicular to the second portion.

18. The display panel cutting method of claim 17, wherein
the first portion of the upper supporting member includes acryl.

19. The display panel cutting method of claim 17, wherein
the upper supporting member is disposed on the display panel cutting apparatus such that a lower surface of the first portion is separated from the upper surface of the test pad portion by 2 mm.

20. The display panel cutting method of claim 17, wherein
the laser generates green light having a wavelength of 500 nm to 550 nm.
